(19) United States
(12) Patent Application Publication
(10) Pub. No.: US 2022/0297298 A1
(43) Pub. Date: Sep. 22, 2022

(54) DATA GENERATION DEVICE, DATA GENERATION METHOD, CONTROL DEVICE, CONTROL METHOD, AND COMPUTER PROGRAM PRODUCT

(71) Applicant: KABUSHIKI KAISHA TOSHIBA, Tokyo (JP)

(72) Inventors: Tatsuya Tanaka, Kawasaki (JP); Toshimitsu Kaneko, Kawasaki (JP)

(73) Assignee: KABUSHIKI KAISHA TOSHIBA, Tokyo (JP)

(21) Appl. No.: 17/446,319

(22) Filed: Aug. 30, 2021

(30) Foreign Application Priority Data
Mar. 18, 2021 (JP) 2021-044782

(51) Int. Cl. B25J 9/16

(52) U.S. Cl. CPC B25J 9/1671; B25J 9/163; B25J 9/1661; B25J 9/1602

(57) ABSTRACT

A control device according to the embodiment includes a deciding unit, a reward generating unit, a simulating unit, and a next-state generating unit. The deciding unit decides on an action based on the state for the present time step. The reward generating unit generates reward based on the state for the present time step and the action. According to a simulated state for the present time step set based on the state for the present time step and according to the action, the simulating unit generates a simulated state for the next time step. The next-state generating unit generates the state for the next time step according to the state for the present time step, the action, and the simulated state for the next time step.

### CROSS-REFERENCE TO RELATED APPLICATIONS

This application is based upon and claims the benefit of priority from Japanese Patent Application No. 2021-044782, filed on Mar. 18, 2021; the entire contents of which are incorporated herein by reference.

### FIELD

Embodiments described herein relate generally to a data generation device, a data generation method, a control device, a control method, and a computer program product.

### BACKGROUND

In the face of labor shortages at the manufacturing/logistics sites, there is a demand for automation of the tasks. In that regard, reinforcement learning is known as a method in which teaching is not required and in which a robot is able to autonomously acquire the operating skills. In reinforcement learning, the operations are learnt by performing actions in a repeated manner through a trial and error process. For that reason, reinforcement learning using an actual robot is generally an expensive way of learning in which data acquisition requires time and efforts. Hence, there has been a demand for a method for enhancing the data efficiency with respect to the number of trials of the actions. As one of such methods, model-based reinforcement learning is conventionally known.

However, by the conventional technologies, for modeling the environment for which the actions or behaviors of a control target are to be learnt, reducing the modeling error is difficult.

### BRIEF DESCRIPTION OF THE DRAWINGS

FIG. 1 is a diagram illustrating an exemplary device configuration of a robot system according to an embodiment;

FIG. 2 is a diagram illustrating an exemplary functional configuration of a data generation device and a control device according to the embodiment;

FIG. 3 is a diagram illustrating an exemplary functional configuration of a generating unit according to the embodiment;

FIG. 4 is a diagram for explaining the operations performed by a simulating unit according to the embodiment;

FIG. 5 is a diagram for explaining an example of the operation for generating reward according to the embodiment;

FIG. 6 is a diagram for explaining the operations performed by a next-state generating unit according to the embodiment;

FIGS. 7, 8A, and 8B are diagrams for explaining an example of the operation for generating the next state according to the embodiment;

FIG. 9 is a diagram for explaining an example in which the operation for generating the reward and the operation for generating the next state are performed using a configuration in which some part of neural networks is used in common;

FIG. 10 is a flowchart for explaining an example of a data generation method according to the embodiment;

FIG. 11 is a flowchart for explaining an example of a control method according to the embodiment; and

FIG. 12 is a diagram illustrating an exemplary hardware configuration of the data generation device and the control device according to the embodiment.

### DETAILED DESCRIPTION

A data generation device according to an embodiment includes one or more hardware processors configured to function as a deciding unit, a reward, a simulating unit, and a next-state generating unit. The deciding unit decides on an action based on a state for present time step. The reward generating unit generates reward based on the state for present time step and the action. The simulating unit generates a simulated state for next time step according to a simulated state for present time step set based on the state for present time step and according to the action. The next-state generating unit generates a state for next time step according to the state for present time step, the action, and the simulated state for next time step. An exemplary embodiment of a data generation device, a data generation method, a control device, a control method, and a computer program product is described below in detail with reference to the accompanying drawings.

In the embodiment, the explanation is given for a robot system that controls a robot having the function of grasping items (an example of objects).

### Example of Device Configuration

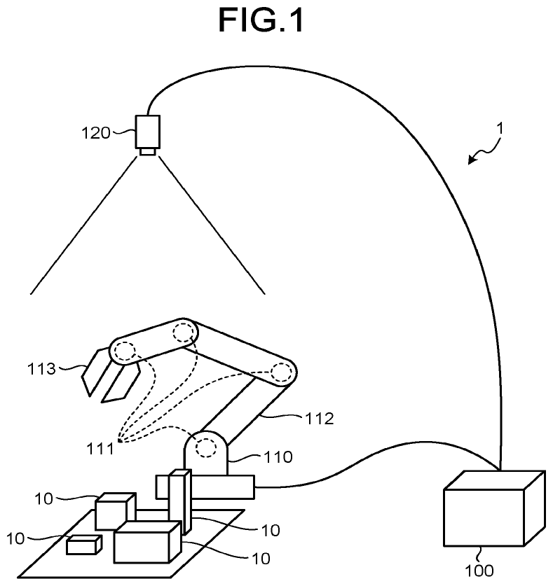

FIG. 1 is a diagram illustrating an exemplary device configuration of a robot system 1 according to the embodiment. The robot system 1 according to the embodiment includes a control device 100, a robot 110, and an observation device 120. The robot 110 further includes a plurality of actuators 111, a multi-joint arm 112, and an end effector 113.

The control device 100 controls the operations of the robot 110. The control device 100 is implemented, for example, using a computer or using a dedicated device used for controlling the operations of the robot 110.

The control device 100 is used at the time of learning a policy for deciding on the control signals to be sent to the actuators 111 for the purpose of grasping items 10. That enables efficient learning of the operation plan of a system in which data acquisition by an actual device, such as the robot 110, is an expensive matter.

The control device 100 refers to observation information that is generated by the observation device 120, and creates an operation plan for grasping an object. Then, the control device 100 sends control signals based on the created operation plan to the actuators 111 of the robot 110, and operates the robot 110.

The robot 110 has the function of grasping the items 10 representing the objects of operation. The robot 110 is configured using, for example, a multi-joint robot, or a cartesian coordinate robot, or a combination of those types of robots. The following explanation is given for an example in which the robot 110 is a multi-joint robot having a plurality of actuators 111.

The end effector 113 is attached to the leading end of the multi-joint arm 112 for the purpose of moving the objects (for example, the items 10). The end effector 113 is, for example, a gripper capable of grasping the objects or a vacuum robot hand. The multi-joint arm 112 and the end effector 113 are controlled according to the driving performed by the actuators 111. More particularly, according to the driving performed by the actuators 111, the multi-joint arm 112 performs movement, rotation, and expansion-contraction (i.e., variation in the angles among the joints). Moreover, according to the driving performed by the actuators 111, the end effector 113 grasps (grips or sucks) the objects.

The observation device 120 observes the state of the items 10 and the robot 110, and generates observation information. The observation device 120 is, for example, a camera for generating images or a distance sensor for generating depth data (depth information). The observation device 120 can be installed in the environment in which the robot 110 is present (for example, on a column or the roof of the same room), or can be attached to the robot 110 itself.

Exemplary Functional Configuration of Control Device

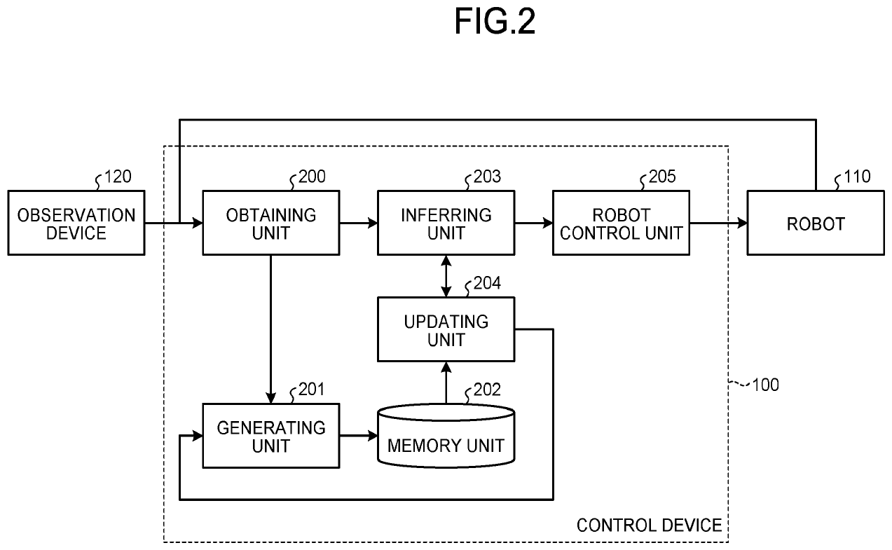

FIG. 2 is a diagram illustrating an exemplary functional configuration of the control device 100 according to the embodiment. The control device 100 according to the embodiment includes an obtaining unit 200, a generating unit 201, a memory unit 202, an inferring unit 203, an updating unit 204, and a robot control unit 205.

The obtaining unit 200 obtains the observation information from the observation device 120 and generates a state sₜ^{o}. The state sₜ^{o} includes the information obtained from the observation information. Moreover, in the state sₜ^{o}, the internal state of the robot 110 (i.e., the angles/positions of the joints, and the position of the end effector) as obtained from the robot 110 can also be included.

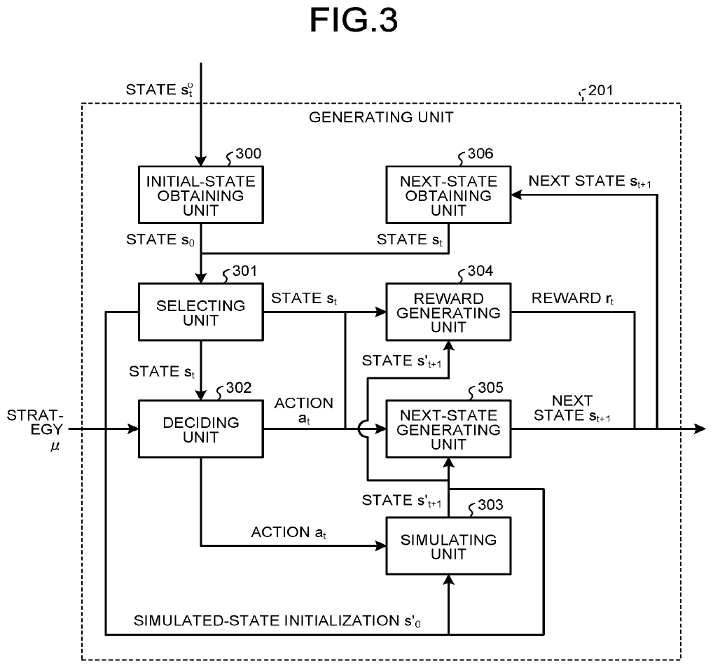

The generating unit 201 receives the state sₜ^{o} from the obtaining unit 200, and generates experience data (sₜ, aₜ, rₜ, sₜ₊₁). Regarding the details of the experience data (sₜ, aₜ, rₜ, sₜ₊₁) and the operations performed by the generating unit 201, the explanation is given later with reference to FIG. 3.

The memory unit 202 is a buffer for storing the experience data generated by the generating unit 201. The memory unit 202 is configured using, for example, a hard disk drive (HDD) or a solid state drive (SSD).

The inferring unit 203 uses the state sₜ^{o} at a time step t and decides on the control signals to be sent to the actuators 111. The inference can be made using various reinforcement learning algorithms. For example, in the case of making the inference using the proximal policy optimization (PPO) explained in Non Patent Literature 2, the inferring unit 203 inputs the state sₜ^{o} in a policy π(a|s); and, based on a probability density function P(a|s) that is obtained, decides on an action aₜ. The action aₜ represents, for example, the control signals used for performing movements, rotation, and expansion-contraction (i.e., variation in the angles among the joints) and for specifying the coordinate position of the end effector.

The updating unit 204 uses the experience data stored in the memory unit 202, and updates the policy π(a|s) of the inferring unit 203. For example, when the policy π(a|s) is modeled by a neural network, the updating unit 204 updates the weight and the bias of the neural network. The weight and the bias can be updated using the error backpropagation method according to the objective function used in the reinforcement learning algorithm such as the PPO.

Based on the output information received from the inferring unit 203, the robot control unit 205 controls the robot 110 by sending controls signals to the actuators 111.

Given below is the explanation of the detailed operations performed by the generating unit 201.

Exemplary Functional Configuration of Generating Unit

FIG. 3 is a diagram illustrating an exemplary functional configuration of the generating unit 201 according to the embodiment. Herein, the explanation for the generating unit 201 constituting the control device 100 is given as the embodiment. Alternatively, it is possible to have a data generation device that constitutes, partially or entirely, the functional configuration of the generating unit 201. The generating unit 201 according to the embodiment includes an initial-state obtaining unit 300, a selecting unit 301, a deciding unit 302, a simulating unit 303, a reward generating unit 304, a next-state generating unit 305, and a next-state obtaining unit 306.

The initial-state obtaining unit 300 obtains the state sₜ^{o} at the start time step of the operations of the robot 110, and treats the state sₜ^{o} as an initial state s₀. The following explanation is given with reference to the state sₜ^{o} obtained at the start time step. However, alternatively, the state sₜ^{o} obtained in the past can be retained and reused; or a data augmentation technology can be implemented based on the observation information observed by the observation device 120, and the state sₜ^{o} can be used in a synthesized manner.

The selecting unit 301 either selects the state s₀ obtained by the initial-state obtaining unit 300, or selects a state sₜ obtained by the next-state obtaining unit 306; and inputs the selected state to the deciding unit 302 and the reward generating unit 304. The states s₀ and sₜ represent the observation information received from the observation device 120. For example, the states s₀ and sₜ can represent either the image information, or the depth information, or both the image information and the depth information. Alternatively, the states s₀ and sₜ can represent the internal state of the robot 110 (such as the angles/positions of the joints, and the position of the end effector) as obtained from the robot 110. Still alternatively, the states s₀ and sₜ can represent a combination of the abovementioned information, or can represent the information obtained by performing arithmetic operations with respect to the abovementioned information. The state sₜ obtained by the next-state obtaining unit 306 represents a state s₍ₜ₋₁₎₊₁ generated for the next time step of the previous instance by the operations performed by the next-state generating unit 305 in the previous instance (for example, the time step t−1). For example, at the start time step of the operations of the robot 110, the selecting unit 301 selects the state s₀; and, at any other time step, the selecting unit 301 selects the state sₜ obtained by the next-state obtaining unit 306.

The deciding unit 302 follows a policy μ and decides on the action aₜ to be taken in the state sₜ. The policy μ can be the policy π(a|s) used by the inferring unit 203, or can be a policy based on some other action deciding criteria other than the inferring unit 203.

The simulating unit 303 simulates the movements of the robot 110. The simulating unit 303 can simulate the movements of the robot 110 using, for example, a robot simulator. Alternatively, for example, the simulating unit 303 can simulate the movements of the robot 110 using an actual device (the robot 110). Meanwhile, the picking targets (for example, the items 10) need not be present during the simulation.

At the operation start time step, the simulating unit 303 initializes the simulated state (i.e. simulated-state initialization s′₀) based on an initialization instruction received from the selecting unit 301. The simulated state can represent, for example, either the image information, or the depth information, or both the image information and the depth information. Alternatively, the simulated state can represent the internal state of the robot 110 (such as the angles/positions of the joints, and the position of the end effector) as obtained from the robot 110. Still alternatively, the simulated state can represent a combination of the abovementioned information, or can represent the information obtained by performing arithmetic operations with respect to the abovementioned information. Firstly, based on the state (for example, the angles of the joints) of the robot 110 at the start time step, the simulating unit 303 corrects its internal state and sets the simulated state to have the same posture/state as the robot 110. Then, based on the action aₜ decided by the deciding unit 302, the simulating unit 303 simulates the state of the robot 110 for the following time step. Subsequently, the simulating unit 303 inputs a simulated state s′ₜ₊₁ of the robot 110 for the following time step, which is obtained by performing simulation, to the next-state generating unit 305. Moreover, if the reward generating unit 304 makes use of the simulated state at the time of calculating a reward rₜ, the simulating unit 303 can input the simulated state s′ₜ₊₁ to the reward generating unit 304 too.

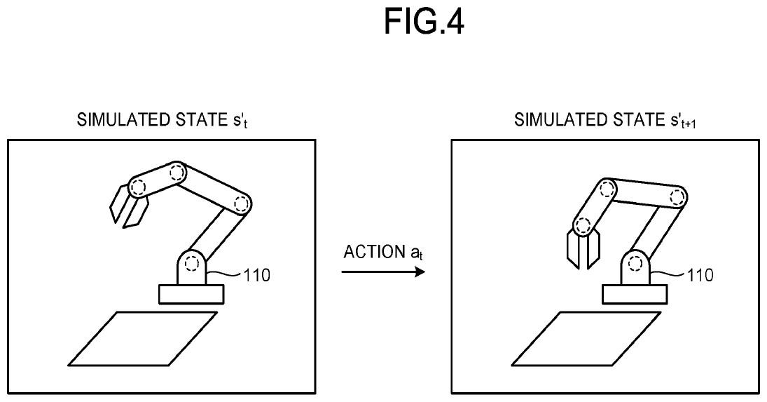

FIG. 4 is a diagram for explaining the operations performed by the simulating unit 303 according to the embodiment. Herein, the explanation is given for the case in which the simulating unit 303 is configured (implemented) using a robot simulator. The simulating unit 303 is a simulator in which the model of a robot (for example, the CAD data, the mass, and the friction coefficient) is equivalent to the robot 110.

The simulating unit 303 generates a simulated state s′ₜ for the time step t. For example, when the observation device is configured using a camera, the simulating unit 303 renders an image equivalent to the image in which the robot 110 is captured from the viewpoint of the observation device 120, and generates the simulated state s′ₜ (i.e., generates the information obtained by observing the simulated state s′ₜ) using the rendered image. Meanwhile, the simulated state s′ₜ can be expressed using the depth information too.

Moreover, based on the action aₜ decided by the deciding unit 302, the simulating unit 303 simulates the state of the robot 110 after the simulated state s′ₜ. After performing the simulation, the simulating unit 303 renders an image equivalent to the image in which the robot 110 is captured from the viewpoint of the observation device 120, and generates the simulated state s′ₜ₊₁ for the time step t+1.

The reward generating unit 304 outputs the reward rₜ that is obtained when the action aₜ is performed in the state sₜ. The reward rₜ can be calculated according to a statistical method such as a neural network. Alternatively, for example, the reward rₜ can be calculated using a predetermined function.

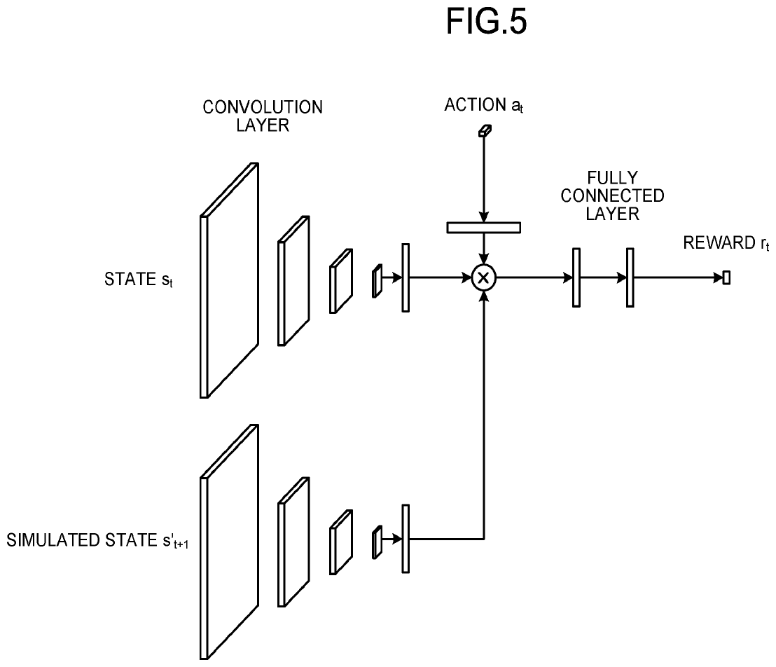

FIG. 5 is a diagram for explaining an example of the operation for generating the reward rₜ according to the embodiment. In the example illustrated in FIG. 5, the reward generating unit 304 is configured (implemented) using a neural network. The following explanation is given for an example in which the state sₜ is expressed using an image.

In the example illustrated in FIG. 5, the state sₜ is subjected to convolution in a convolution layer and is then subjected to processing in a fully connected layer, and gets a Dₛ-dimensional feature as a result. Moreover, the action aₜ is subjected to processing in the fully connected layer and gets a Dₐ-dimensional feature as a result. Then, the Dₛ-dimensional feature and the Dₐ-dimensional feature are concatenated and subjected to processing in the fully connected layer, and the reward rₜ is calculated as a result. After the processing in the convolution layer and the fully connected layer is performed, a conversion operation using an activating function, such as a rectified linear function or a sigmoid function, can also be performed.

Meanwhile, the reward rₜ can be generated also using the simulated state s′ₜ₊₁. In the case of generating the reward rₜ further based on the simulated state s′ₜ₊₁ for the next time step, the reward generating unit 304 performs operations with respect to the simulated state s′ₜ₊₁ that are identical to the operations performed with respect to the simulated state sₜ; further concatenates a D_{s′}-dimensional feature to the Dₛ-dimensional feature and the Dₐ-dimensional feature; performs processing in the fully connected layer; and calculates the reward rₜ as a result.

The weight and the bias of the neural network, which constitutes the reward generating unit 304, is obtained from the training data of the experience data (sₜ, aₜ, rₜ, sₜ₊₁). The training data of the experience data (sₜ, aₜ, rₜ, sₜ₊₁) is collected by, for example, operating the robot system 1 illustrated in FIG. 1. More particularly, the reward generating unit 304 compares the reward rₜ obtained in the neural network constituting the reward generating unit 304 with the reward rₜ of the training data; and obtains the weight and the bias of the neural network using the error backpropagation method in such a way that, for example, the square error is minimized.

Returning to the explanation with reference to FIG. 3, the next-state generating unit 305 generates the state (next state) sₜ₊₁ for the next time step based on the state sₜ selected by the selecting unit 301, the action aₜ decided by the deciding unit 302, and the simulated state s′ₜ₊₁ of the robot 110 as generated for the following time step by the simulating unit 303. As far as the method for calculating the state sₜ₊₁ is concerned, a statistical method such as a neural network is used.

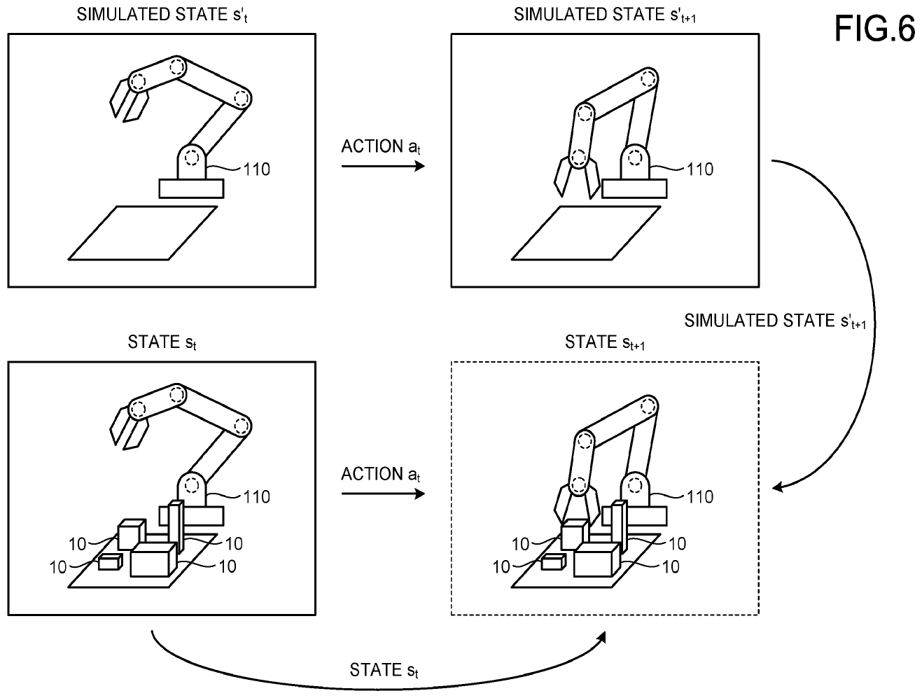

FIG. 6 is a diagram for explaining the operations performed by the next-state generating unit 305 according to the embodiment. With reference to FIG. 6, the next-state generating unit 305 performs operations to generate the state sₜ₊₁ for the next time step. Herein, the next-state generating unit 305 generates the state sₜ₊₁ for the next time step based on the state sₜ, the simulated state s′ₜ₊₁, and the action aₜ. In the example illustrated in FIG. 6, the state sₜ is expressed using the image observed by the observation device 120. The simulated state s′ₜ₊₁ is expressed using the image rendered by the simulating unit 303. The action aₜ represents the action decided by the deciding unit 302.

Meanwhile, regarding the state sₜ, the state sₜ₊₁, the simulated state s′ₜ, and the simulated state s′ₜ₊₁; the method of expression is not limited to the image format. Alternatively, for example, the state sₜ, the state sₜ₊₁, the simulated state s′ₜ, and the simulated state s′ₜ₊₁ can include at least either an image or the depth information.

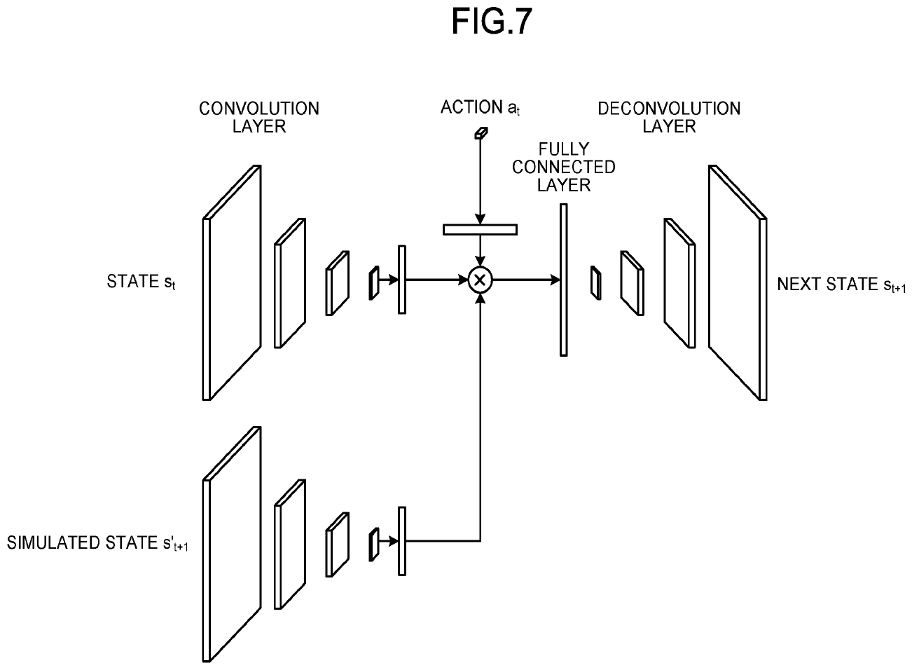

FIG. 7 is a diagram for explaining an example of the operation for generating the next state according to the embodiment. In the example illustrated in FIG. 7, the next-state generating unit 305 is configured using a neural network. The following explanation is given for the example in which the state sₜ is expressed as an image. The state sₜ is subjected to convolution in the convolution layer and is then subjected to processing in the fully connected layer, and gets the Dₛ-dimensional feature as a result. Moreover, the action aₜ is subjected to processing in the fully connected layer and gets the Dₐ-dimensional feature as a result. Then, the Dₛ-dimensional feature and the Dₐ-dimensional feature are concatenated and subjected to processing in the fully connected layer, and are then subjected to deconvolution in a deconvolution layer. As a result, the next state sₜ₊₁ is generated.

Meanwhile, the next state sₜ₊₁ can be generated also using the simulated state s′ₜ₊₁. In that case, the simulated state s′ₜ₊₁ is subjected to identical processing to the processing performed with respect to the state s′ₜ, and the D_{s′}-dimensional feature is obtained. Then, the D_{s′}-dimensional feature is further concatenated to the Dₛ-dimensional feature and the Dₐ-dimensional feature, and is subjected to processing in the fully connected layer. That is followed by deconvolution in the deconvolution layer, and the next state sₜ₊₁ is generated as a result.

After the processing in the convolution layer, the fully connected layer, and the deconvolution layer is performed; a conversion operation using an activating function, such as a normalization linear function or a sigmoid function, can also be performed.

The weight and the bias of the neural network constituting the next-state generating unit 305 is obtained from the training data of the experience data (sₜ, aₜ, rₜ, sₜ₋₁). The training data of the experience data (sₜ, aₜ, rₜ, sₜ₊₁) is collected by, for example, operating the robot system 1 illustrated in FIG. 1. More particularly, the next-state generating unit 305 compares the next state sₜ₊₁ obtained in the neural network constituting the next-state generating unit 305 with the next state sₜ₊₁ of the training data; and obtains the weight and the bias of the neural network using the error backpropagation method in such a way that, for example, the square error is minimized.

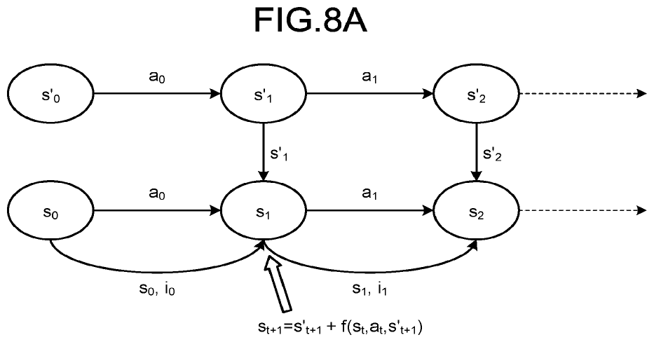

FIGS. 8A and 8B are diagrams for explaining an example of the operation for generating the next state sₜ₊₁ according to the embodiment. In the control device 100 according to the embodiment, as illustrated in FIG. 8A, the state sₜ₊₁ of the robot 110 at the next time step can be generated based on the simulated state s′ₜ₊₁ that is generated by the simulating unit 303 (for example, a robot simulator). For that reason, it suffices for the next-state generating unit 305 to generate, as correction information, only the information (sₜ, aₜ, s′ₜ₊₁) related to the state of the picking targets such as the items 10 (for example, the positions, the sizes, the shapes, and the postures of the items 10) at the next time step (in practice, since there can be some error between the robot 110 and the robot simulator, that error too is generated as part of the correction information).

That is, in the control device 100 according to the embodiment, the next-state generating unit 305 generates correction information to be used in correcting the simulated state s′ₜ₊₁ for the next time step, and generates the state sₜ₊₁ for the next time step from the correction information and from the simulated state s′ₜ₊₁ for the next time step. As a result, it becomes possible to reduce the errors related to the robot 110, and to reduce the modeling error.

Conventionally, not only the state sₜ₊₁ of the robot 110 at the next time step needs to be generated, but the state of the picking targets at the next time also needs to be generated. Moreover, conventionally, the next state sₜ₊₁ is generated based only on the state sₜ and the action aₜ. Hence, it is difficult to reduce the modeling error.

Meanwhile, during the learning of a picking operation according to the embodiment, a broad layout of the robot 110 and the objects (for example, the items 10) is known. Hence, for example, if the observation device 120 is configured using a camera, a pattern recognition technology can be implemented and the region of the objects (for example, the items 10) can be detected from the obtained image. That is, the next-state generating unit 305 can extract a region iₜ, which includes the objects, from at least either the image or the depth information; and can generate the state sₜ₊₁ for the next time step based on the region including the objects. For example, the next-state generating unit 305 clips, in advance, the region of the objects (for example, the items 10) from the image, and generates the next state sₜ₊₁ using the information iₜ indicating that region. That enables achieving further reduction in the modeling error.

Returning to the explanation with reference to FIG. 3, the next-state obtaining unit 306 obtains the next state sₜ₊₁ generated by the next-state generating unit 305; treats the next state sₜ₊₁ as the state sₜ to be used in the operations in the next instance (the operations at the next time step); and inputs that state sₜ to the selecting unit 301.

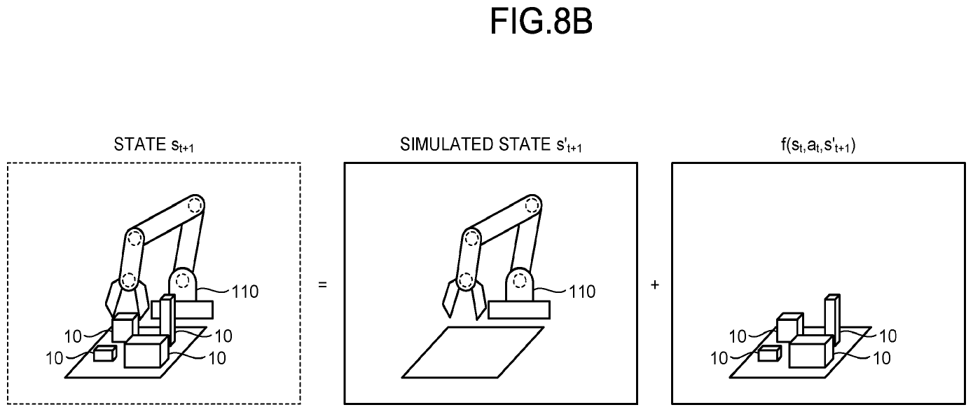

Meanwhile, in the explanation given above, the reward generating unit 304 and the next-state generating unit 305 separately generate the reward rₜ and the next state sₜ₊₁, respectively. However, if both constituent elements are configured using neural networks, some part of the neural networks can be used in common as illustrated in FIG. 9.

FIG. 9 is a diagram for explaining an example in which the operation for generating the reward rₜ and the operation for generating the next state sₜ₊₁ are performed using a configuration in which some part of the neural networks is used in common. As illustrated in the example in FIG. 9, by using some part of the neural networks in common, it can be expected to achieve enhancement in the learning efficiency of the neural networks.

### Example of Data Generation Method

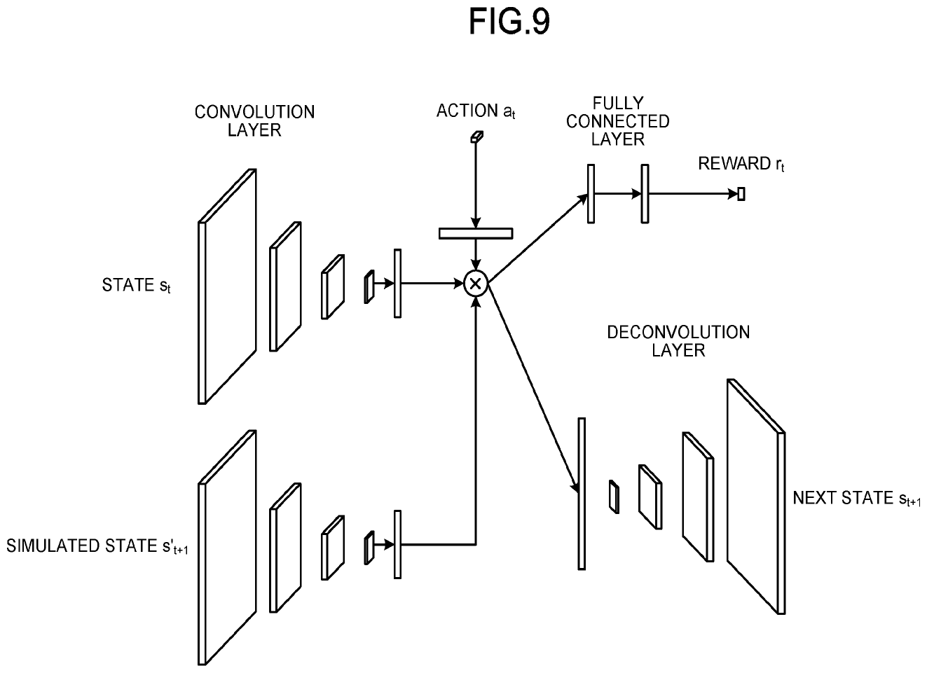

FIG. 10 is a flowchart for explaining an example of a data generation method according to the embodiment. Firstly, the selecting unit 301 obtains the state s₀ (the initial state) or obtains the state sₜ (the state sₜ₊₁ generated for the next time step by the operations performed by the next-state generating unit 305 in the previous instance) (Step S1). Then, the selecting unit 301 selects the state s₀ or the state sₜ, which is obtained at Step S1, as the state sₜ for the present time step (Step S2).

Subsequently, the deciding unit 302 decides on the action aₜ based on the state sₜ for the present time step (Step S3). Then, the reward generating unit 304 generates the reward rₜ based on the state sₜ for the present time step and based on the action aₜ (Step S4). Subsequently, according to the simulated state s′ₜ for the present time step, which is set based on the state sₜ for the present time step, and according to the action aₜ; the simulating unit 303 generates the simulated state s′ₜ₊₁ for the next time step (Step S5). Then, the next-state generating unit 305 generates the state sₜ₊₁ according to the state sₜ for the present time step, the action aₜ, and the simulated state s′ₜ₊₁ for the next time step (Step S6).

The experience data is stored in the memory unit 202 by the operations from Step S1 to Step S6 or by performing those operations in a repeated manner.

### Example of Control Method

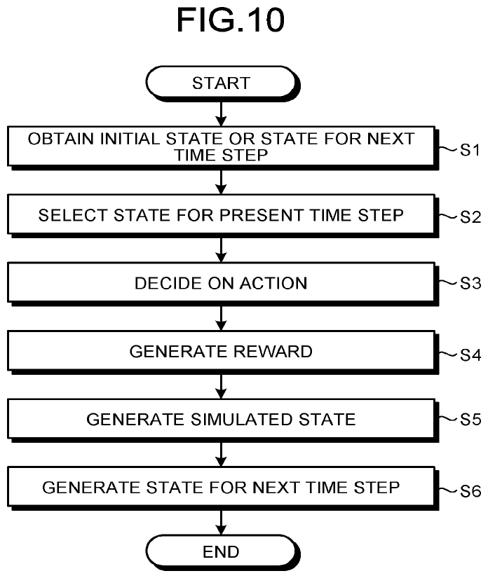

FIG. 11 is a flowchart for explaining an example of a control method according to the embodiment. Herein, the operations from Step S1 to Step S6 are identical to the operations performed in the data generation method. Hence, that explanation is not given again. After the state sₜ₊₁ for the next time step is generated at Step S6, based on the policy π obtained by performing reinforcement learning according to the experience data that contains the state sₜ for the present time step, the action aₜ for the present time step, the reward rₜ for the present time step, and the state sₜ₊₁ for the next time step; the inferring unit 203 decides on the control signals used for controlling the control target (in the embodiment, the robot 110). Meanwhile, the policy π is updated by the updating unit 204 using the experience data stored in the memory unit 202. The experience data is stored in the memory unit 202 by the operations from Step S1 to Step S6 or by performing those operations in a repeated manner.

Thus, the updating unit 204 updates the policy π using the experience data stored in the memory unit 202. Based on the policy π obtained by performing reinforcement learning according to the experience data that contains the state sₜ for the present time step, the action aₜ for the present time step, the reward rₜ for the present time step, and the state sₜ₊₁ for the next time step; the inferring unit 203 decides on the control signals used for controlling the control target (in the embodiment, the robot 110) (Step S7).

As explained above, in the control device 100 according to the embodiment, at the time of modeling the environment for learning the operations of the control target, it becomes possible to reduce the modeling error.

In the conventional technology, at the time of modeling the environment for learning the operations of a robot, a modeling error occurs. Generally, the modeling error occurs because it is difficult to completely model and reproduce the operations of the robot. When the operations of a robot are learnt according to the experience data generated using a modeled environment, there is a possibility that the desired operations cannot be implemented in an actual robot because of the modeling error.

On the other hand, in the control device 100 according to the embodiment, during the model-based reinforcement learning, it becomes possible to generate the experience data (sₜ, aₜ, rₜ, sₜ₊₁) having a reduced modeling error. More particularly, at the time of generating the state sₜ₊₁ for the next time step, the simulated state s′ₜ₊₁ generated by the simulating unit 303 is used. As a result, it becomes possible to reduce the error regarding the information that can be simulated by the simulating unit 303. That enables achieving reduction in the error in the learning data that is generated. Hence, in the actual robot 110 too, the desired operations can be implemented with a higher degree of accuracy as compared to the conventional case.

### Example of Hardware Configuration

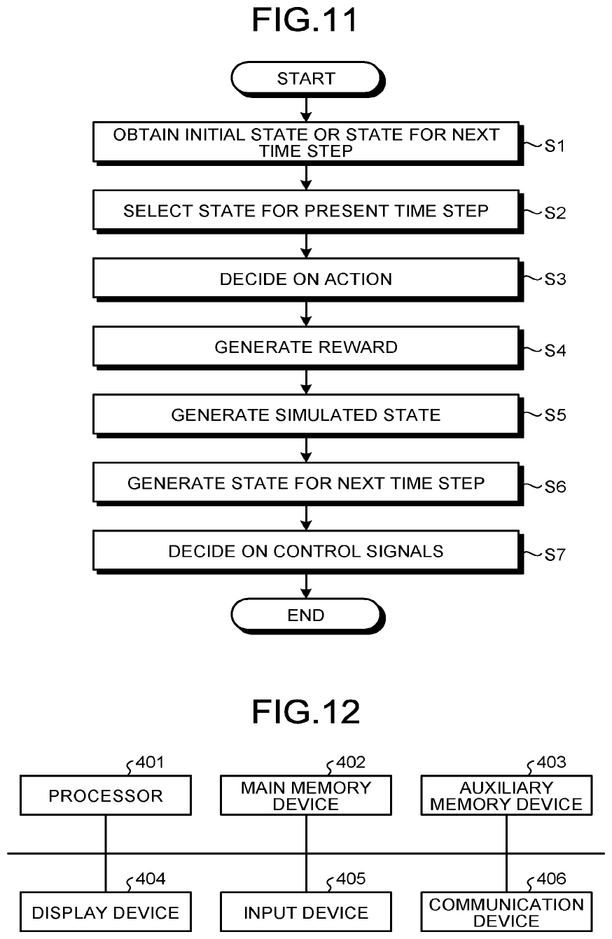

FIG. 12 is a diagram illustrating an exemplary hardware configuration of the control device 100 according to the embodiment. The control device 100 according to the embodiment includes a processor 401, a main memory device 402, an auxiliary memory device 403, a display device 404, an input device 405, and a communication device 406. The processor 401, the main memory device 402, the auxiliary memory device 403, the display device 404, the input device 405, and the communication device 406 are connected to each other via a bus 410.

The processor 401 executes computer programs that are read from the auxiliary memory device 403 into the main memory device 402. The main memory device 402 is a memory such as a read only memory (ROM) or a random access memory (RAM). The auxiliary memory device 403 is a hard disk drive (HDD) or a memory card.

The display device 404 displays display information. Examples of the display device 404 include a liquid crystal display. The input device 405 is an interface for enabling operation of the control device 100. Examples of the input device 405 include a keyboard or a mouse. The communication device 406 is an interface for communicating with other devices. Meanwhile, the control device 100 need not include the display device 404 and the input device 405. If the control device 100 does not include the display device 404 and the input device 405; then, for example, the settings of the control device 100 are performed from another device via the communication device 406.

The computer programs executed by the control device 100 according to the embodiment are recorded as installable files or executable files in a computer-readable memory medium such as a compact disc read only memory (CD-ROM), a memory card, a compact disc recordable (CD-R), or a digital versatile disc (DVD); and are provided as a computer program product.

Alternatively, the computer programs executed by the control device 100 according to the embodiment can be stored in a downloadable manner in a network such as the Internet. Still alternatively, the computer programs executed by the control device 100 according to the embodiment can be distributed via a network such as the Internet without involving downloading.

Still alternatively, the computer programs executed by the control device 100 according to the embodiment can be stored in advance in a ROM.

The computer programs executed by the control device 100 according to the embodiment have a modular configuration including the functional blocks that can be implemented also using computer programs. As actual hardware, the processor 401 reads the computer programs from a memory medium and executes them, so that the functional blocks get loaded in the main memory device 402. That is, the functional blocks get generated in the main memory device 402.

Meanwhile, some or all of the functional blocks can be implemented without using software but using hardware such as an integrated circuit (IC).

Moreover, the functions can be implemented using a plurality of processors 401. In that case, each processor 401 can be configured to implement one of the functions, or can be configured to implement two or more functions.

Furthermore, it is possible to have an arbitrary operation form of the control device 100 according to the embodiment. Thus, some of the functions of the control device 100 according to the embodiment can be implemented as, for example, a cloud system in a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data generation device comprising:
one or more hardware processors configured to function as:
a deciding unit that decides on an action based on a state for present time step;
a reward generating unit that generates reward based on the state for present time step and the action;
a simulating unit that, according to a simulated state for present time step set based on the state for present time step and according to the action, generates simulated a state for next time step; and
a next-state generating unit that generates a state for next time step according to the state for present time step, the action, and the simulated state for next time step.

2. The data generation device according to claim 1, wherein the reward generating unit generates the reward further based on the simulated state for next time step.

3. The data generation device according to claim 1, wherein the next-state generating unit generates
correction information to be used for correcting the simulated state for next time step, and
the state for next time step according to the correction information and the simulated state for next time step.

4. The data generation device according to claim 2, wherein the state for present time step, the state for next time step, the simulated state for present time step, and the simulated state for next time step include at least either an image or depth information.

5. The data generation device according to claim 4, wherein the simulating unit generates the simulated state for next time step using a robot simulator or a robot.

6. The data generation device according to claim 5, wherein the next-state generating unit
extracts a region including a picking target from at least either the image or the depth information, and
generates the state for next time step further based on the region including the picking target.

7. The data generation device according to claim 1, wherein the one or more hardware processors are configured to further function as:
an initial-state obtaining unit that obtains an initial state;
a next-state obtaining unit that obtains the state for next time step generated in previous instance by operation performed in previous instance by the next-state generating unit; and
a selecting unit that selects the state for present time step according to the initial state or according to the state for next time step generated in previous instance.

8. A control device comprising:
the data generation device according to claim 1; and
an inferring unit that decides on a control signal used for controlling a control target, based on a policy obtained by performing reinforcement learning from experience data that contains the state for present time step, the action, the reward, and the state for next time step.

9. A data generation method comprising:
deciding on, by a deciding unit, an action based on a state for present time step;
generating, by a reward generating unit, reward based on the state for present time step and the action;
generating, by a simulating unit, a simulated state for next time step according to a simulated state for present time step set based on the state for present time step and according to the action; and
generating, by a next-state generating unit, a state for next time step according to the state for present time step, the action, and the simulated state for next time step.

10. The data generation method according to claim 9, wherein the generating the reward includes generating the reward further based on the simulated state for next time step.

11. The data generation method according to claim 9, wherein the generating the state for next time step includes
generating correction information to be used for correcting the simulated state for next time step, and
generating the state for next time step according to the correction information and the simulated state for next time step.

12. The data generation method according to claim 11, wherein the state for present time step, the state for next time step, the simulated state for present time step, and the simulated state for next time step include at least either an image or depth information.

13. The data generation method according to claim 12, wherein the generating the state for next time step includes
extracting a region including a picking target from at least either the image or the depth information, and
generating the state for next time step further based on the region including the picking target.

14. The data generation method according to claim 9, further comprising:
obtaining, by an initial-state obtaining unit, an initial state;
obtaining, by a next-state obtaining unit, the state for next time step generated in previous instance by operation performed in previous instance of the generating the state for next time step; and
selecting, by a selecting unit, the state for present time step according to the initial state or according to the state for next time step generated in previous instance.

15. A control method comprising:
the data generation method according to claim 9; and
deciding on a control signal used for controlling a control target, based on a policy obtained by performing reinforcement learning from experience data that contains the state for present time step, the action, the reward, and the state for next time step.

16. A computer program product having a non-transitory computer readable medium including programmed instructions, wherein the instructions, when executed by a computer, cause the computer to function as:
a deciding unit that decides on an action based on a state for present time step;
a reward generating unit that generates reward based on the state for present time step and the action;
a simulating unit that, according to a simulated state for present time step set based on the state for present time step and according to the action, generates a simulated state for next time step; and
a next-state generating unit that generates a state for next time step according to the state for present time step, the action, and the simulated state for next time step.

17. The computer program product according to claim 16, wherein the reward generating unit generates the reward further based on the simulated state for next time step.

18. The computer program product according to claim 16, wherein the next-state generating unit generates
correction information to be used for correcting the simulated state for next time step, and
the state for next time step according to the correction information and the simulated state for next time step.

19. The computer program product according to claim 18, wherein the state for present time step, the state for next time step, the simulated state for present time step, and the simulated state for next time step include at least either an image or depth information.

20. The computer program product according to claim 19, wherein the simulating unit generates the simulated state for next time step using a robot simulator or a robot.

21. The computer program product according to claim 20, wherein the next-state generating unit
extracts a region including a picking target from at least either the image or the depth information, and
generates the state for next time step further based on the region including the picking target.

22. The computer program product according to claim 16, further causing the computer to function as:
an initial-state obtaining unit that obtains an initial state;
a next-state obtaining unit that obtains the state for next time step generated in previous instance by operation performed in previous instance by the next-state generating unit; and
a selecting unit that selects the state for present time step according to the initial state or according to the state for next time step generated in previous instance.

23. A computer program product having a non-transitory computer readable medium including programmed instructions, wherein the instructions, when executed by a computer, cause the computer to function as:
each function of the computer program product according to claim 16; and
an inferring unit that decides on a control signal used for controlling a control target, based on a policy obtained by performing reinforcement learning from experience data that contains the state for present time step, the action, the reward, and the state for next time step.
